(19) United States
(12) Patent Application Publication
(10) Pub. No.: US 2023/0354727 A1
(43) Pub. Date: Nov. 9, 2023

(54) COMBINATION GARDEN TOOL

(71) Applicant: Little Mountain Enterprises, Rutherfordton, NC (US)

(72) Inventor: Brent L. Cordes, Rutherfordton, NC (US)

(21) Appl. No.: 17/738,046

(22) Filed: May 6, 2022

(51) Int. Cl. A01B 1/20; A01B 1/24; A01B 1/02; A01B 1/14; A01B 1/16

(52) U.S. Cl. CPC A01B 1/20; A01B 1/243; A01B 1/022; A01B 1/14; A01B 1/16

(57) ABSTRACT

A combination garden tool includes an elongate shaft extending along a central longitudinal axis. The shaft has a first end and a second end. A spade extends along the central longitudinal axis. The spade is attached to the first end of the shaft. A multi-tine cultivator extends from the second end of the shaft, generally orthogonally to the central longitudinal axis. A sickle extends from the second end of the shaft, away from the cultivator.

### BACKGROUND OF THE INVENTION

### Field of the Invention

The invention relates to a gardening tool that includes a spade, a sickle, and a three-tine cultivator.

### Description of the Related Art

Different garden tools are used to perform different functions in a garden. It can often be quite cumbersome to carry and use several different gardening tools, such as a spade, a sickle, and a three-tine cultivator, to perform the necessary work in a garden.

It would be beneficial to provide a combination tool that includes the above-mentioned tools all on a single shaft to allow a gardener to work their garden without an excessive number of tools or storage requirements.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a combination garden tool that includes an elongate shaft extending along a central longitudinal axis. The shaft has a first end and a second end. A spade extends along the central longitudinal axis. The spade is attached to the first end of the shaft. A multi-tine cultivator extends from the second end of the shaft, generally orthogonally to the central longitudinal axis. A sickle extends from the second end of the shaft, away from the cultivator.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is perspective view of a combination gardening tool according to an exemplary embodiment of the present invention;

FIG. 2 is a front elevational view of the tool of FIG. 1;

FIG. 3 is a rear elevational view of the tool of FIG. 1;

FIG. 4 is a left side elevational view of the tool of FIG. 1;

FIG. 5 is a right side elevational view of the tool of FIG. 1;

FIG. 6 is a top plan view of the tool of FIG. 1; and

FIG. 7 is a bottom plan view of the tool of FIG. 1.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

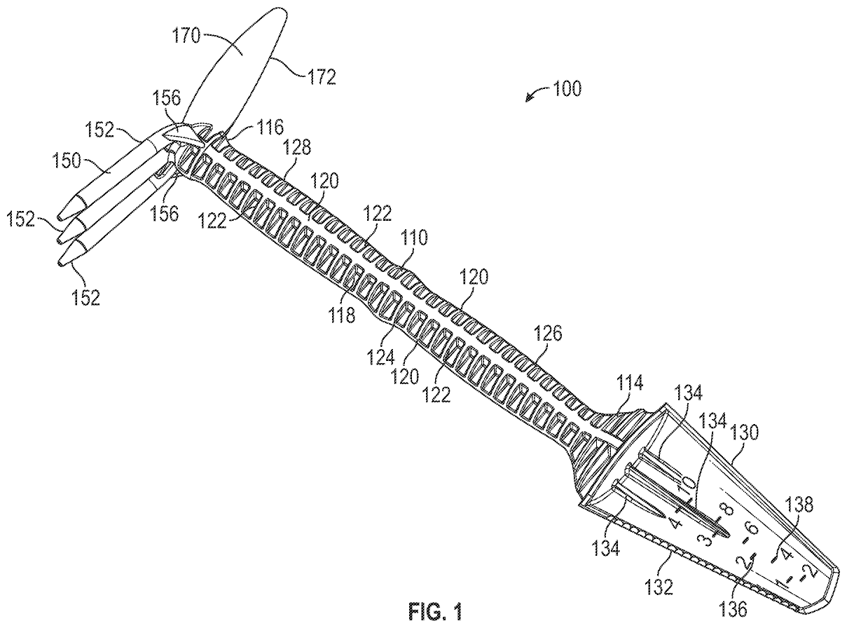

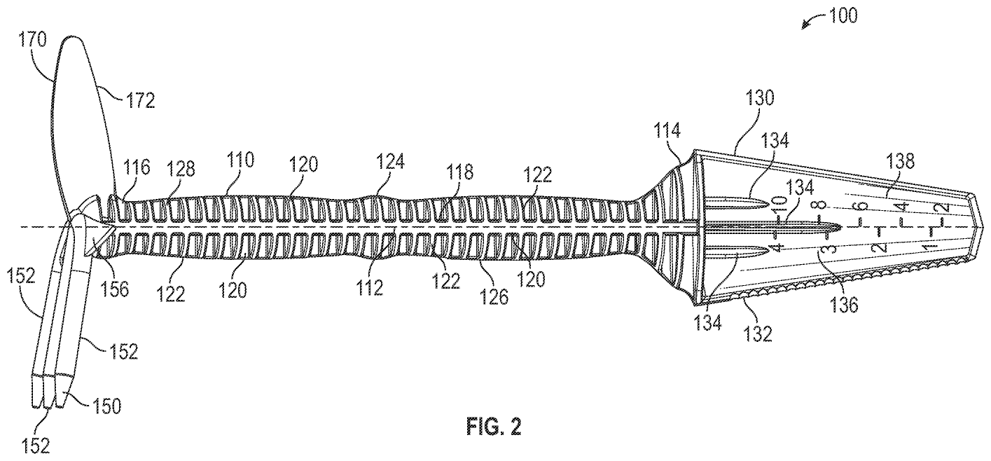

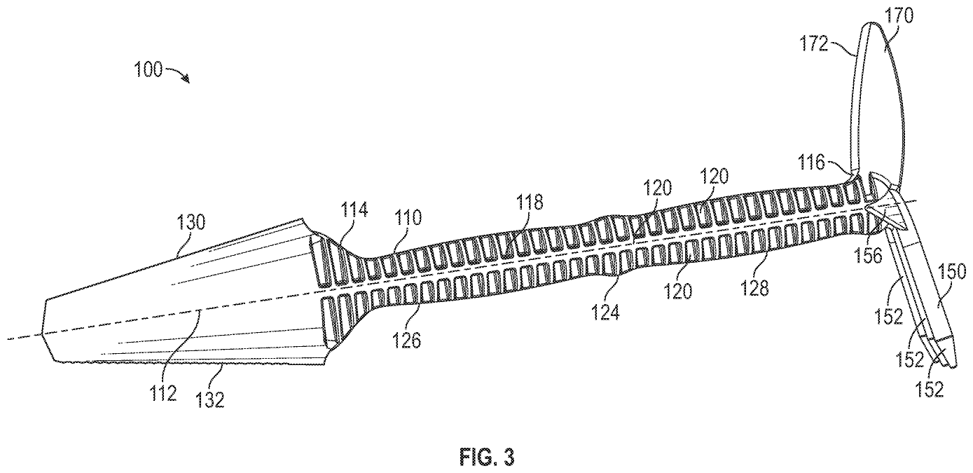

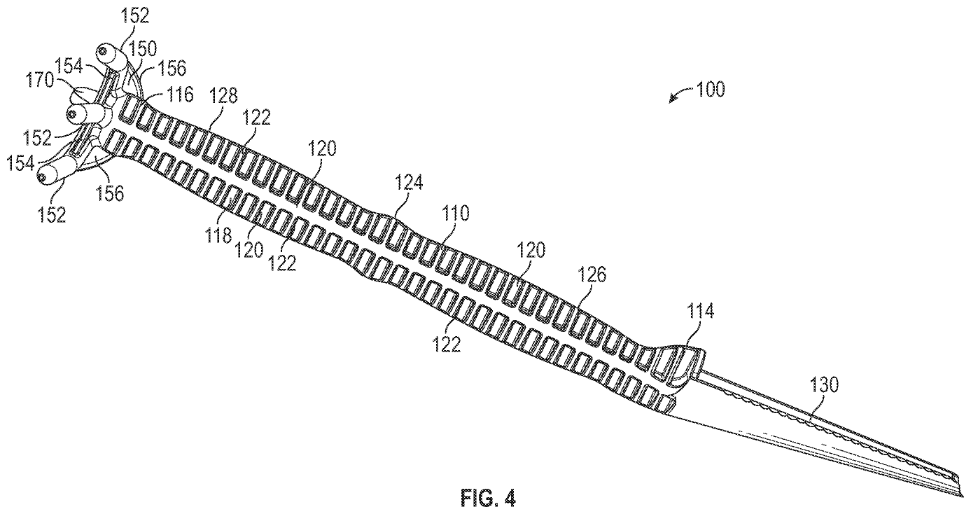

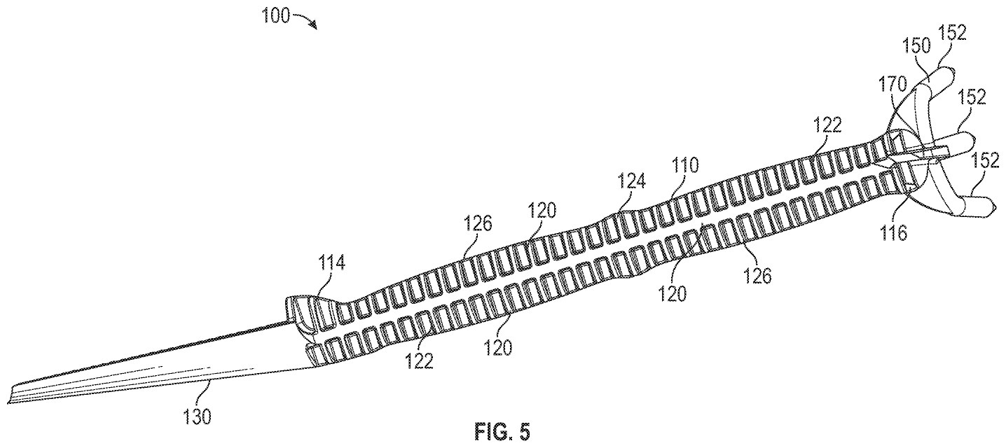

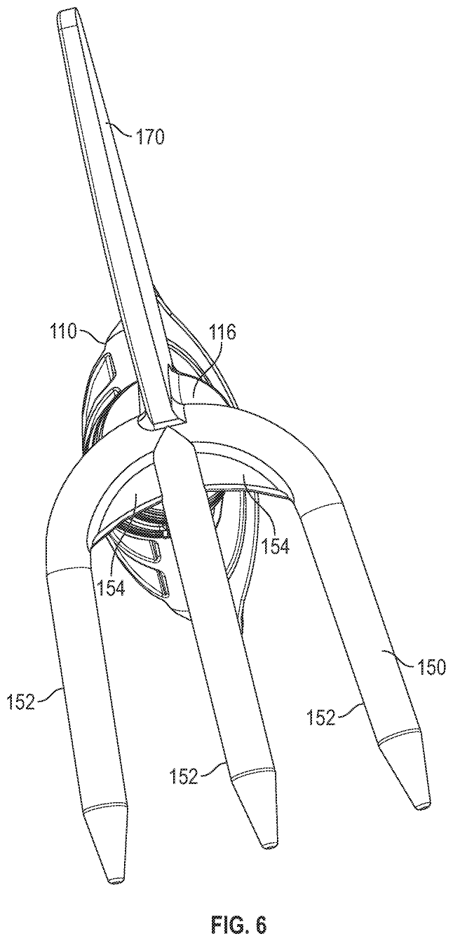

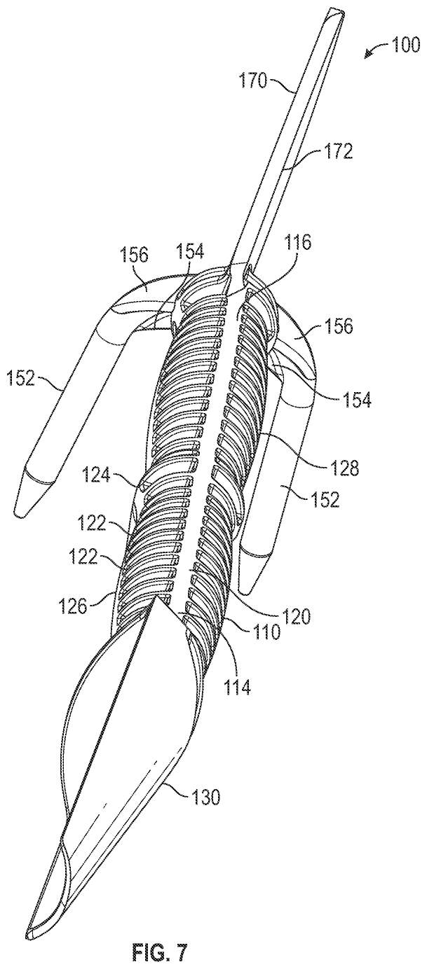

A combination garden tool 100 (“tool 100”) according to an exemplary embodiment of the present invention is shown in FIGS. 1-7. Tool 100 is used to perform many tasks in a garden that typically require numerous tools to perform, and can reduce the time to perform such gardening tasks as well as reduce tool storage requirements.

Tool 100 includes an elongate shaft 110 that extends along a central longitudinal axis 112. Shaft 110 includes a first end 114 and a second end 116, distal from the first end 114. A spade 130 extends along the central longitudinal axis 112, with spade 130 being attached to first end 114 of shaft 110. A multi-tine cultivator 150 extends from second end 116 of shaft 110, generally orthogonally to central longitudinal axis 112. A sickle 170 extends from second end 116 of shaft 110, away from cultivator 150.

Tool 100 is of unitary construction and can be formed or molded from a reinforced polymer, such as, by way of example only, polycarbonate/acrylonitrile butadiene styrene (PC-ABS). Due to its polymer construction, tool 100 is relatively lightweight compared to prior art garden tools of a comparable size. Additionally, tool 100 is corrosion and rust resistant, leading to a potentially long life span than prior art garden tools.

Shaft 110 comprises a central body portion 118 and a plurality of longitudinal ribs 120 extending around the central body portion 118. In an exemplary embodiment, four ribs 120 are provided, each rib 120 spaced about 90 degrees radially around central body portion 118 from an adjacent rib 120. Shaft 110 further comprises a plurality of radial ribs 122 extending orthogonally to the longitudinal ribs 120.

Shaft 110 also includes a bulge portion 124 approximately half way between the first end 114 and the second end 116 of shaft 110. Bulge portion 124. Shaft 110 also includes a first convex portion 126 between the bulge portion 124 and the first end 114 and a second convex portion 128 between the bulge portion 124 and the second end 116. Ribs 120, 122, bulge portion 124 and convex portions 126,128 provide an ergonomic, easy grip handle for a user.

Shaft 110 is expanded at the first end 114 to accommodate spade 130 and to provide reinforcement at the junction of shaft 110 and spade 130. Spade 130 includes a serrated edge 132 to assist in opening potting soil and fertilizer bags (not shown). Spade 130 also includes a plurality of longitudinally extending parallel ribs 134 to reinforce spade 130 and provide additional durability to spade 130. Spade 130 further includes a depth scale 136 using standard markings, and a separate depth scale 138 using metric markings.

Shaft 110 is expanded at second end 116 to accommodate both cultivator 130 and sickle 170 and to provide reinforcement at the junction of shaft 110 with cultivator 130 and sickle 170. Cultivator 150 has three tines 152 that are used to loosen and prepare soil and remove weeds. In an exemplary embodiment, tines 152 can extend about three inches in length with rounded tips to prevent soil build-up. Cultivator 150 further includes a transverse gusset 154 connecting adjacent ones of each of the three tines 152 to provide added strength to tines 152. Additionally, cultivator 150 includes an edge gusset 156 connecting each of the outer tines 152 to shaft 110. Transverse and edge gussets 154, 156 provide strength and support to tines 152.

Sickle 170 is an ergonomically angled blade that slices through soil to detach roots and aerate and loosen soil. In an exemplary embodiment, sickle 170 can be about three and a half inches long, with a convex edge 172 proximal to the shaft 110. Edge 172 has a sharp point, similar to a knife blade.

It will be further understood that various changes in the details, materials, and arrangements of the parts which have been described and illustrated in order to explain the nature of this invention may be made by those skilled in the art without departing from the scope of the invention as expressed in the following claims.

I claim:

1. A combination garden tool comprising:
an elongate shaft extending along a central longitudinal axis, the shaft having a first end and a second end;
a spade extending along the central longitudinal axis, the spade being attached to the first end of the shaft;
a multi-tine cultivator extending from the second end of the shaft, generally orthogonally to the central longitudinal axis; and
a sickle extending from the second end of the shaft, away from the cultivator.

2. The combination garden tool according to claim 1, wherein the shaft comprises a central body portion and a plurality of longitudinal ribs extending around the central body portion.

3. The combination garden tool according to claim 2, wherein the shaft further comprises a plurality of radial ribs extending orthogonally to the longitudinal ribs.

4. The combination garden tool according to claim 3, wherein the longitudinal ribs and the radial ribs form a grip.

5. The combination garden tool according to claim 1, wherein the shaft comprises a bulge portion between the first end and the second end.

6. The combination garden tool according to claim 1, wherein the shaft comprises a first convex portion between the bulge portion and the first end.

7. The combination garden tool according to claim 1, wherein the shaft comprises a second convex portion between the bulge portion and the second end.

8. The combination garden tool according to claim 1, wherein the first end of the shaft is expanded at the first end.

9. The combination garden tool according to claim 1, wherein the second end of the shaft is expanded at the second end.

10. The combination garden tool according to claim 1, wherein the tool is of unitary construction.

11. The combination garden tool according to claim 1, wherein the spade comprises a serrated edge.

12. The combination garden tool according to claim 1, wherein the spade comprises a plurality of longitudinally extending parallel ribs.

13. The combination garden tool according to claim 1, wherein the spade comprises a plurality of depth scales.

14. The combination garden tool according to claim 1, wherein the cultivator comprises three tines.

15. The combination garden tool according to claim 14, wherein the cultivator further comprises a transverse gusset connecting adjacent of each of the three tines.

16. The combination garden tool according to claim 14, wherein the cultivator further comprises an edge gusset connecting outer tines of the three tines to the shaft.

17. The combination garden tool according to claim 1, wherein the sickle comprises a convex edge distal from the shaft.

18. The combination garden tool according to claim 17, wherein the convex edge has a sharp point.
